(19) United States
(12) Patent Application Publication
(10) Pub. No.: US 2023/0415368 A1
(43) Pub. Date: Dec. 28, 2023

(54) FOAM CONTOUR-CUTTING MACHINE

(71) Applicant: Sorin Adrian MUNTEANU, Chino, CA (US)

(72) Inventor: Sorin Adrian MUNTEANU, Chino, CA (US)

(21) Appl. No.: 18/336,306

(22) Filed: Jun. 16, 2023

Related U.S. Application Data
(60) Provisional application No. 63/354,724, filed on Jun. 23, 2022.

(51) Int. Cl. B26D 3/00; B26D 1/50

(52) U.S. Cl. CPC B26D 3/006; B26D 1/50

(57) ABSTRACT

A contour-cutting machine for cutting a foam block, such as a polyurethane foam block into foam rows, such as pillows, has high productivity. The contour-cutting machine has multiple cutting tools that can be operated simultaneously to cut the foam block. Each cutting tool has a blade that cuts through the foam block. For example, an upper cutting tool and a lower cutting tool mounted over a pillar one above each other can be positioned at a predefined distance from each other and locked together. Each cycle of the process makes two cuts with the two cutting tools in the foam block.

### CROSS-REFERENCE TO RELATED APPLICATIONS

This application claims priority from a U.S. Provisional Patent Application Ser. No. 63/354,724, filed on Jun. 23, 2022, the disclosure of which is incorporated herein by reference in their entirety.

### FIELD OF INVENTION

The present invention relates to a contour-cutting machine, and more particularly, the present invention relates to a high production capacity contour-cutting machine for polyurethane foam.

### BACKGROUND

Specialized machines are available for contour-cutting of polyurethane foam in a variety of shapes using different cutting tool choices. Chiefly, the choices are continuous blades (closed loop), reciprocating blades (vibrating), and abrasive wires. Each of the available cutting tools has its advantages and disadvantages but all of them share one common limitation i.e., speed. The known cutting tools for use in foam contour-cuttings for acceptable tolerance results, the machine has to be operated at a very slow speed that limits efficiency and productivity. Increasing the speed of the machine to cut faster, past the maximum ability of the cutting tool to go thru the material results in bowing and deformation of the cutting tool.

An industry need is there for improvements in contour-cutting of foams, especially improvements in productivity and performance.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to the contour-cutting machine for foams that have improved productivity and efficiency.

It is another object of the present invention that the contour-cutting machine has multiple cutting tools that can work simultaneously.

It is another object of the present invention that the contour-cutting machine can cut foam in a variety of shapes and contours.

It is yet another object of the present invention that the contour-cutting machine is versatile in operation.

It is a further object of the present invention that the speed of the contour-cutting machine can be customized as and when desired.

It is still a further object of the present invention that the contour-cutting machine makes the process of foam cutting more economical, faster, and with more production capacity.

In one aspect, disclosed is a contour-cutting foam machine comprising a platform mounted over rails, the rails mounted over a frame, the platform configured to move horizontally over the rails; two vertical pillars, spaced apart from each other, mounted to the frame; and a plurality of cutting tools mounted over the two vertical pillars, each cutting tool of the plurality of cutting tools is configured to move up and down over the two vertical pillars, and a blade is coupled to each cutting tool of the two vertical pillars, the blade is configured to cut a foam block.

In one aspect, the platform is configured to be turned from a horizontal state to a vertical state.

In one aspect, the two vertical pillars comprise a first pillar and a second pillar, each cutting tool of the plurality of cutting tools comprises a first member and a second member, the blade extends between the first member and the second member, the first member coupled to the first pillar and the second member coupled to the second pillar.

In one aspect, the contour-cutting foam machine further comprises a plurality of cutting tool frames mounted to the frame, each cutting tool frame of the plurality of cutting tool frames comprises a first arm and a second arm, the plurality of cutting tools is coupled to respective plurality of cutting tool frames, wherein the first member of the cutting tool is coupled to the first arm and the second member of the cutting tool is coupled to the second arm. The blade is a closed loop cutting blade.

In one aspect, the plurality of cutting tools comprises an upper cutting tool and a lower cutting tool, the plurality of cutting tool frames comprises an upper cutting tool frame and a lower cutting tool frame, the upper cutting tool is configured to be positioned at a pre-determined distance from the lower cutting tool, and the upper cutting tool and the lower cutting tool are configured to be locked together at the pre-determined distance.

In one aspect, the plurality of cutting tools comprises an upper cutting tool and a lower cutting tool, the plurality of cutting tool frames comprises an upper cutting tool frame and a lower cutting tool frame, the upper cutting tool and the lower cutting tool are configured to operate independently of each other.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of the contour-cutting machine for foam blocks, according to an exemplary embodiment of the present invention.

FIG. 2 is another perspective view of the contour-cutting machine for foam blocks, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

### REFERENCE NUMERALS

100 contour-cutting machine,
102 platform,
104 rails,
106 frame,
108 support pad,
110 upper tool frame,
112 lower tool frame,
114 vertical columns,
116 upper blade tool;
118 lower blade tool;
120 upper blade clamp;
122 lower blade clamp.

A contour-cutting machine for cutting foam blocks is disclosed that has multiple cutting tools for cutting a foam block. The disclosed contour-cutting machine can be used for contour-cutting of polyurethane foam blocks and the like foam blocks. The multiple cutting tools in the disclosed contour-cutting machine can be operated independently of each other or synchronized together to increase productivity and produce a variety of shapes and contours in the foam block. The disclosed contour-cutting machine increases productivity and efficiency, and at the same time, occupies lesser floor area in comparison to having multiple conventional contour-cutting machines. The disclosed contour-cutting machine can have two or more cutting tools, wherein “n” number of cutting tools can increase the productivity “n” times.

The main advantage of the disclosed contour-cutting machine is that the cutting tools can be arranged in a single tool frame with a variety of cutting tool path configurations, or in separate tool frames, where one tool frame is for each cutting tool. These frames can be of different designs and can be located in different arrangements relative to each other.

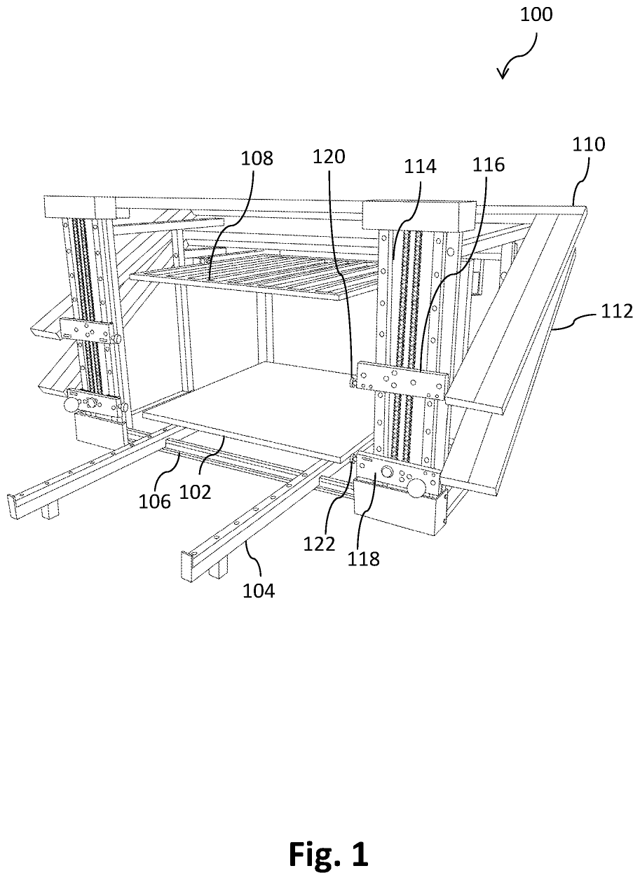

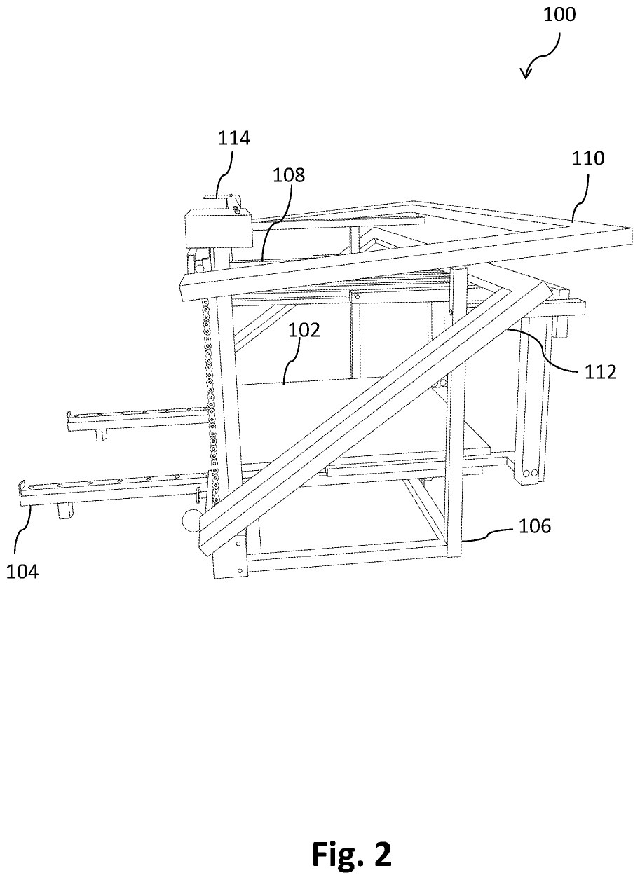

Referring to FIGS. 1 and 2 which show different perspective views of the disclosed contour-cutting machine. The contour-cutting machine 100 can include platform 102 mounted over horizontal rails 104 and the platform is connected to a conveyor belt(s) arrangement that can move the platform horizontally over the rails. A foam block can be placed over the platform and the foam block moves horizontally with the platform. The movement of the platform can be precisely controlled using a control unit of the disclosed contour-cutting machine. It is understood that one or more foam blocks to be cut into desired shapes and sizes can be placed on the platform. Also, the platform can be substituted with any supporting structure that can keep the foam block stable and moves the foam block horizontally relative to the cutting blades. For example, the supporting structure can be just the conveyor belt.

The disclosed contour-cutting machine can include a frame 106 to which the different components including the rails can be mounted. The frame can as a backbone of the disclosed contour-cutting machine. The frame can be made from any strong and durable material, such as steel. The frame can be mounted on the floor of a building in an upright configuration. The disclosed machine can also include a pad 108 that is mounted above the platform, wherein pad 108 can compress the foam block placed on the platform to keep it stable during the cutting process. The pad, upon placing the foam block, can be lowered over the foam block, wherein the pad can compress over the foam block thereby stabilizing the foam block.

Two vertical pillars or columns 114 are also shown in FIG. 1, which are coupled to the frame and are upstanding from the base of the frame. The pillars can support the cutting tools of the disclosed machine. A suitable actuation mechanism and rails can be provided mounted to the pillars for moving the cutting tools vertically over the pillar. Preferably, such an actuation mechanism can have high precision for moving the cutting tools, wherein the actuation mechanism can be operably coupled to the control unit of the disclosed machine. A belt running across the vertical pillar can be seen in FIG. 1 for moving the respective cutting tools. The cutting tools can move up and down over the pillars relative to a foam block placed over the platform. The control unit can control the movement of the cutting tool and the platform to be synchronized with each other.

The disclosed machine can also include cutting tool frames that support the cutting tools over the two pillars. For each cutting tool, a respective cutting tool frame can be provided, wherein the cutting tool frame is mounted to the frame of the machine and the vertical pillar. FIG. 1 shows two cutting tools mounted to two cutting tool frames i.e., an upper tool frame 110 to which an upper cutting tool 116 is mounted and a lower cutting tool frame 112 to which a lower cutting tool frame 118 can be mounted. Each cutting tool frame has two arms to which two members of a cutting tool are mounted. The two members of a cutting tool are mounted to the two pillars respectively as shown in the drawings. A cutting blade for cutting the foam can extend between the two members of the cutting tool.

The cutting tools can be arranged on the vertical pillar at predetermined positions one over another spaced apart from each other. Each of the cutting tools can be connected to an independent actuation mechanism, the different actuation mechanisms can be connected to a common control unit. Alternatively, two more cutting tools can be connected to a common actuation mechanism. The control unit can control the operation of different cutting tools including keeping the cutting tool in synchronization while cutting. Keeping the multiple cutting tools operating simultaneously and in synchronization is a critical feature of the invention that maintains the stability of the foam block while cutting. In one example, a polyurethane foam block can be placed on the platform and settled in place by the pad. The pad can be mounted to the frame or the platform and can move with the platform. The foam block can lay flat horizontally over the platform. The position of the cutting tools can be set based on the width of the rows to be cut from the foam block, for example, the rows of 4 inches may be desired. The operator can set the positions of the upper cutting blade and the lower cutting blade based on the row height. In this case, the two cutting blades can be set apart at 4 inches i.e., 4 inches difference between the upper and lower cutting tool. It is understood that for this example, the operator is setting the distance between the lower blade and the upper blade to 4 inches, however, this may vary depending on the desired height of each foam row. When the upper blade is properly distanced from the lower blade, both blades can be locked together, both moving up and down together in unison being linked together.

The operator can now only program to add rows of parts, 1, 3, 5, 7, . . . for the lower blade. When the machine is started, the upper blade moves in synchronization with the lower blade, and will cut rows 2, 4, 6, 8, . . . while the lower blade cuts rows 1, 3, 5, 7, . . . simultaneously with the upper blade. Therefore, productivity is doubled compared to convention cutting machines.

The foam block can be moved horizontally while the cutting tool moves vertically, by the control unit, to cut the foam block. The scheme of cutting the foam block can be pre-programmed in the control unit using a suitable interface. In one implementation, the foam block can be placed vertically on the platform. The machine can be equipped with a plurality of conveyor belts, the cutting tools arranged vertically traveling between conveyors. They can be set at different distances from one another similar to the previous arrangement, but everything can be shifted 90 degrees.

The control unit can be coupled to a display and input interface, wherein the control unit can receive instructions through the input interface and present information on the display. An operator can operate the disclosed contour-cutting machine through the input interface and the multiple blades are arranged horizontally on the vertical plane on top of each other moving together or separately on this vertical plane. The orientation of all cutting tools is synchronized electrically or mechanically to operate in the same direction during the cutting process. The majority of the foam parts are cut in horizontal rows and vertical columns arrangement.

The cutting tool can include suitable motors to drive the blades, such as reciprocating motors. The blades used can be closed-loop cutting blades (like a band saw). With such blades, the cutting speed is much higher, without the problems of material displacement or creating dust. The foam block does not collapse or change dimension, resulting in better tolerance. On these multiple cutting tools, it is desired that the rotation sense of travel alternate in CW and CCW direction to minimize the effect they have on the foam block and the tendency of the block to be pushed sideways by the rotary movement of the cutting tool. Each cutting tool further has a motor to rotate the blades wherein such motors are coupled to the control unit. The blades can be coupled to the cutting tool through clamps. FIG. 1 shows a upper blade clamp 120 for the upper cutting tool and a lower blade clamp 122 for the lower cutting tool. Each cutting tools has two members between which the blade extends. Both members work in synchronization for cutting the foam block.

In certain implementations, the disclosed machine can be equipped with in-feed and out-feed foam block devices or be constructed in a “double wide” configuration to further increase productivity.

In certain implementations, the disclosed system can be customized to achieve desired productivity. High productivity can be achieved by using dual blades simultaneously in the machine for cutting the foam block. However, when such high productivity is not needed, the single blade can be used. Also, a situation may arise when the dual blades cannot be used, such as when the foam block is to be cut into larger-size foams. In such cases, the upper cutting tool can be detached from the lower cutting tool, and the upper cutting tool can be moved upwards and parked. The cutting process can be performed using a single cutting tool.

In certain implementations, the platform of the disclosed machine can be turned 90 degrees, this feature is referred to herein as the “turntable” option. This allows the operator to cut the parts from the foam block in different directions. For example, the blades, being continuous cutting contours, the products may look similar to cutting “logs” or “extruded” parts. After the first program is finished, cutting all the contours, the operator can then turn the platform and thus the foam block by 90 degrees, this provides an ability to “slice” these contours “logs” or “extrusions” to any thickness that is needed by creating a simple vertical slicing program, or any other contour if desired. For example, cutting a pillow the first program will cut one profile, when the turntable is shifted 90 degrees, it can cut the other profile, completing the pillow.

In a preferred embodiment of the present invention, the multiple blades mounted to the multiple cutting tools are aligned parallel to each other while cutting the foam blocks. The use of multiple cutting tools increases the productivity of cutting the foam block multiple times.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A contour-cutting foam machine comprising:
a platform mounted over rails, the rails mounted over a frame, the platform configured to move horizontally over the rails;
two vertical pillars, spaced apart from each other, mounted to the frame; and
a plurality of cutting tools mounted over the two vertical pillars, each cutting tool of the plurality of cutting tools is configured to move up and down over the two vertical pillars, and a blade is coupled to each cutting tool of the two vertical pillars, the blade is configured to cut a foam block, wherein blades mounted to the plurality of cutting tools are aligned parallel to each other.

2. The contour-cutting foam machine of claim 1, wherein the platform is configured to be turned from a horizontal state to a vertical state.

3. The contour-cutting foam machine of claim 1, wherein the two vertical pillars comprise a first pillar and a second pillar, each cutting tool of the plurality of cutting tools comprises a first member and a second member, the blade extends between the first member and the second member, the first member coupled to the first pillar and the second member coupled to the second pillar.

4. The contour-cutting foam machine of claim 3, wherein the contour-cutting foam machine further comprises:
a plurality of cutting tool frames mounted to the frame, each cutting tool frame of the plurality of cutting tool frames comprises a first arm and a second arm, the plurality of cutting tools is coupled to respective plurality of cutting tool frames, wherein the first member of the cutting tool is coupled to the first arm and the second member of the cutting tool is coupled to the second arm.

5. The contour-cutting foam machine of claim 4, wherein the blade is a closed loop cutting blade.

6. The contour-cutting foam machine of claim 4, wherein the plurality of cutting tools comprises an upper cutting tool and a lower cutting tool, the plurality of cutting tool frames comprises an upper cutting tool frame and a lower cutting tool frame, the upper cutting tool is configured to be positioned at a pre-determined distance from the lower cutting tool, and the upper cutting tool and the lower cutting tool are configured to be locked together at the pre-determined distance.

7. The contour-cutting foam machine of claim 4, wherein the plurality of cutting tools comprises an upper cutting tool and a lower cutting tool, the plurality of cutting tool frames comprises an upper cutting tool frame and a lower cutting tool frame, the upper cutting tool and the lower cutting tool are configured to operate independently of each other.

8. A method of cutting a foam block using a contour-cutting foam machine into rows, the method comprises:
providing the contour-cutting foam machine comprising:
a platform mounted over rails, the rails mounted over a frame, the platform configured to move horizontally over the rails,
two vertical pillars, spaced apart from each other, mounted to the frame, and
a plurality of cutting tools mounted over the two vertical pillars, each cutting tool of the plurality of cutting tools is configured to move up and down over the two vertical pillars, and a blade is coupled to each cutting tool of the two vertical pillars, the blade is configured to cut a foam block, wherein blades mounted to the plurality of cutting tools are aligned parallel to each other;
placing the foam block onto the platform; and
cutting the foam block into rows by the plurality of cutting tools.

9. The method of claim 8, wherein the platform is configured to be turned from a horizontal state to a vertical state.

10. The method of claim 8, wherein the two vertical pillars comprise a first pillar and a second pillar, each cutting tool of the plurality of cutting tools comprises a first member and a second member, the blade extends between the first member and the second member, the first member coupled to the first pillar and the second member coupled to the second pillar.

11. The method of claim 10, wherein the contour-cutting foam machine further comprises:
a plurality of cutting tool frames mounted to the frame, each cutting tool frame of the plurality of cutting tool frames comprises a first arm and a second arm, the plurality of cutting tools is coupled to respective plurality of cutting tool frames, wherein the first member of the cutting tool is coupled to the first arm and the second member of the cutting tool is coupled to the second arm.

12. The method of claim 11, wherein the blade is a closed loop cutting blade.

13. The method of claim 11, wherein the plurality of cutting tools comprises an upper cutting tool and a lower cutting tool, the plurality of cutting tool frames comprises an upper cutting tool frame and a lower cutting tool frame, the upper cutting tool is configured to be positioned at a pre-determined distance from the lower cutting tool, and the upper cutting tool and the lower cutting tool are configured to be locked together at the pre-determined distance.

14. The method of claim 11, wherein the plurality of cutting tools comprises an upper cutting tool and a lower cutting tool, the plurality of cutting tool frames comprises an upper cutting tool frame and a lower cutting tool frame, the upper cutting tool and the lower cutting tool are configured to operate independently of each other.
